(19) United States
(12) Patent Application Publication
(10) Pub. No.: US 2024/0009617 A1
(43) Pub. Date: Jan. 11, 2024

(54) DIRECT AIR CAPTURE CONTACTOR FOR CARBON UPTAKE, AND METHODS OF OPERATING THE SAME

(71) Applicant: Heirloom Carbon Technologies, Inc., Brisbane, CA (US)

(72) Inventors: Andy DUBEL, Moss Beach, CA (US); Charlie KARR, San Francisco, CA (US); Juhi KALRA, San Francisco, CA (US); David DRENNAN, Springfield, NH (US); Noah PAUL-GIN, San Francisco, CA (US); Isabel GUEBLE, Sunnyvale, CA (US); Shazib ELAHI, Fremont, CA (US)

(21) Appl. No.: 18/348,112

(22) Filed: Jul. 6, 2023

Related U.S. Application Data
(60) Provisional application No. 63/358,602, filed on Jul. 6, 2022.

(51) Int. Cl. B01D 53/18; B01D 53/14; B01D 53/62; B01D 53/78

(52) U.S. Cl. CPC B01D 53/185; B01D 53/1475; B01D 53/62; B01D 53/78; B01D 2257/504; B01D 2258/06; B01D 2251/404; B01D 2251/602; B01D 2251/604; B01D 2251/402; B01D 2251/304

(57) ABSTRACT

Embodiments described herein relate to systems, devices, and methods for uptake of CO₂ from ambient air. In some aspects, a device can include a platform with a top portion and a bottom portion, an elevation mechanism configured to move the platform vertically, a plurality of orifices defined by the top portion of the platform, the plurality of orifices configured to dispense liquid toward a tray, and an actuator configured to move laterally along a bottom side of the top portion of the platform, the actuator configured to urge the tray to move laterally. In some embodiments, the bottom portion can support the tray as the tray moves laterally. In some embodiments, the elevation mechanism can include at least one of a chain or a linear actuator driven by a motor.

### CROSS-REFERENCE TO RELATED APPLICATIONS

This application claims priority to U.S. Provisional Application No. 63/358,602, filed Jul. 6, 2022 and titled “Direct Air Capture Contactor For Carbon Uptake, and Methods of Operating the Same,” the disclosure of which is hereby incorporated by reference in its entirety.

### TECHNICAL FIELD

Embodiments described herein relate systems and methods for uptake of carbon dioxide (CO₂) from ambient air.

### BACKGROUND

The atmospheric concentration of CO₂ has reached 410 parts per million by volume (ppm), an increase of almost 20 ppm in the last 10 years. As current emission levels exceed 35 GtCO₂/year, a diverse portfolio of CO₂ mitigation technologies must be developed and strategically deployed to avoid a 2° C. increase in Earth's temperature by 2100. Due to global reliance on fossil fuels, this portfolio must include technologies that can remove current and future CO₂ emissions from the atmosphere, some of which include the acceleration of natural processes such as the CO₂ uptake of oceans and the terrestrial biosphere (soils, forests, minerals), bioenergy with carbon capture and storage (BECCS), and synthetic approaches using chemicals also known as direct air capture with storage (DACS) technologies. Inclusion of moisture in air capture medium can improve the uptake of CO₂. Efficiency of water delivery to the carbon capture medium affects the overall efficiency of a system employing a carbon capture medium.

### SUMMARY

Embodiments described herein relate to systems, devices, and methods for uptake of CO₂ from ambient air. In some aspects, a device can include a platform with a top portion and a bottom portion, an elevation mechanism configured to move the platform vertically, a plurality of orifices defined by the top portion of the platform, the plurality of orifices configured to dispense liquid toward a tray, and an actuator configured to move laterally along a bottom side of the top portion of the platform, the actuator configured to urge the tray to move laterally. In some embodiments, the bottom portion can support the tray as the tray moves laterally. In some embodiments, the elevation mechanism can include at least one of a chain or a linear actuator driven by a motor. In some embodiments, the tray can include a carbonation medium disposed therein. In some embodiments, the carbonation medium can include at least one of calcium oxide, calcium hydroxide, magnesium oxide, magnesium hydroxide, sodium oxide, sodium hydroxide, or dolomitic lime (calcium-magnesium oxide or hydroxide).

### BRIEF DESCRIPTION OF THE DRAWINGS

FIG. 1 is a block diagram of a contactor unit for direct air capture (DAC), according to an embodiment.

FIG. 2 is a block diagram of a distributor incorporated into a DAC system, according to an embodiment.

FIGS. 3A-3G are illustrations of a contactor unit and various components thereof, according to an embodiment.

FIG. 4 is an illustration of a network of contactor units, according to an embodiment.

FIG. 5 is an illustration of a distributor, according to an embodiment.

FIG. 6 is an illustration of a distributor, according to an embodiment.

FIGS. 7A-7E are illustrations of a shelf and its interactions with cables, according to an embodiment.

FIG. 8 is an illustration of a shelf, according to an embodiment.

FIG. 9 is a block diagram of a method of operating a distributor, according to an embodiment.

### DETAILED DESCRIPTION

DAC contactors are used to hold, process, distribute, and/or re-collect carbonation medium in a cyclic DAC process. Contactors described herein can hold trays, move trays within a system, process carbonation medium in trays to maintain high CO₂ uptake, fill trays, dispense, and/or dispense/collect saturated carbonation medium for regeneration. A fill station of a contactor can distribute a thin layer of capture material onto a tray. The tray is then picked up by a distributor. The distributor can pick up, move, dispense, and process trays and materials. Contactors can include a collection of vertical bars, and the distributors can traverse the bars of the contactor. Processing of carbonation medium can include addition of water to the carbonation medium to improve the CO₂ uptake of the carbonation medium.

Distributors described herein can include mechanisms to pick trays, process trays, and release trays to a specified location inside the contactor. Distributors described herein can also measure weights of trays. In some embodiments, distributors described herein can encase a weighing platform. The processing of the trays can include adding water, agitating the carbonation medium, and/or any other form of processing. The distributor can pick the tray from a tray filling station or tray filling location and use the picking mechanism to move the tray into the body of the distributor. The distributor can then move vertically to align the tray to a proper rack and shelf location on the contactor, where the distributor delivers the tray to the proper location. This can be repeated until each shelf on the contactor has a tray.

The frequency of the processing of trays can be dictated by software and control algorithms. Processing can continue until the carbonation medium reaches a suitable reaction extent. In some embodiments, processing the trays can include misting a carbonation medium in the trays or other methods for controlled water distribution, or mechanical agitation of the materials. Processing can continue until the carbonation medium reaches a suitable reaction extent. In some embodiments, processing the trays can include misting water onto the carbonation medium in the trays or other methods for controlled water distribution or mechanical agitation of the materials. Processing can continue until the carbonation medium reaches a suitable reaction extent. Once the material has reacted sufficiently, the distributor can pick each tray individually and move it to a collection station. In the collection station, material can be removed from each tray. The tray can then be sent back to the filling station. The collected material can be sent to a regeneration process.

In some embodiments, the contact between the carbonation medium and the ambient air can include any of the strategies described in U.S. patent application Ser. No. 18/067,896 (“the '897 application”), filed Dec. 19, 2022, and titled, “Systems and Methods of Carbon Capture from Cement Production Processes,” the disclosure of which is hereby incorporated by reference in its entirety. In some embodiments, the carbonation medium and/or the contactors described herein can have any of the properties described in International Patent Publication No. 2020/263910 (“the '910 publication”), filed Jun. 24, 2020, and titled, “Systems and Methods for Enhanced Weathering and Calcining for CO₂ Removal from Air,” the disclosure of which is hereby incorporated by reference in its entirety. In some embodiments, the carbonation medium and/or the contactors described herein can have any of the properties described in International Patent Publication No. WO2022187336 (“the '336 publication”), filed Mar. 2, 2022, and titled, “Systems and Methods for Enhanced Weathering and Calcining for CO₂ Removal from Air,” the disclosure of which is hereby incorporated by reference in its entirety. Benefits of interactions between water and carbonation medium are described in greater detail in the '910 publication and the '336 publication.

As used herein, “carbonation plot,” includes single contiguous plots, as well as semi- or non-contiguous plots that are then grouped or processed together to effectively act as a single plot. In some embodiments, carbonation plots include a composition that sequesters a target compound (e.g., CO₂). In some embodiments, carbonation plots are positioned and configured to expose the composition to ambient conditions. In some embodiments, carbonation plots can include a composition that sequesters a target compound.

As used herein, “stream” can refer to stream that includes solid, liquid, and/or gas. For example, a stream can include a solid in granular form conveyed on a conveyor device. A stream can also include a liquid and/or gas flowing through a pipe. A stream can include a solution.

As used herein, “carbonation medium” refers to a medium that can take on carbon dioxide when exposed to ambient air. This can include but is not limited to calcium oxide (CaO), calcium hydroxide (Ca(OH)₂), magnesium oxide (MgO), magnesium hydroxide (MgOH), sodium oxide (Na₂O), sodium hydroxide (NaOH), and/or dolomitic lime (calcium-magnesium oxide or hydroxide). Carbonation medium can originate from a natural source (e.g., limestone). Carbonation medium can also be regenerated or recycled (i.e., a regenerated carbonated medium from a calciner).

As used herein, “carbonated medium” refers to a carbonation medium that has taken up carbon dioxide from ambient air. This can include but is not limited to calcium carbonate (CaCO₃), magnesium carbonate (MgCO₃), sodium carbonate (Na₂CO₃), sodium bicarbonate (NaHCO₃), mixed calcium-magnesium carbonate phases ((Ca,Mg)CO₃). Carbonated medium can be converted back to a carbonation medium (e.g., via the use of a calciner, a dissolution/precipitation-based system, and/or an electrochemical system).

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of contactors, the set of contactors can be considered as one contactor with multiple portions, or the set of contactors can be considered as multiple, distinct contactors. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “about” and “approximately” generally means plus or minus 10% of the value stated, e.g., about 250 μm would include 225 μm to 275 μm, about 1,000 μm would include 900 μm to 1,100 μm.

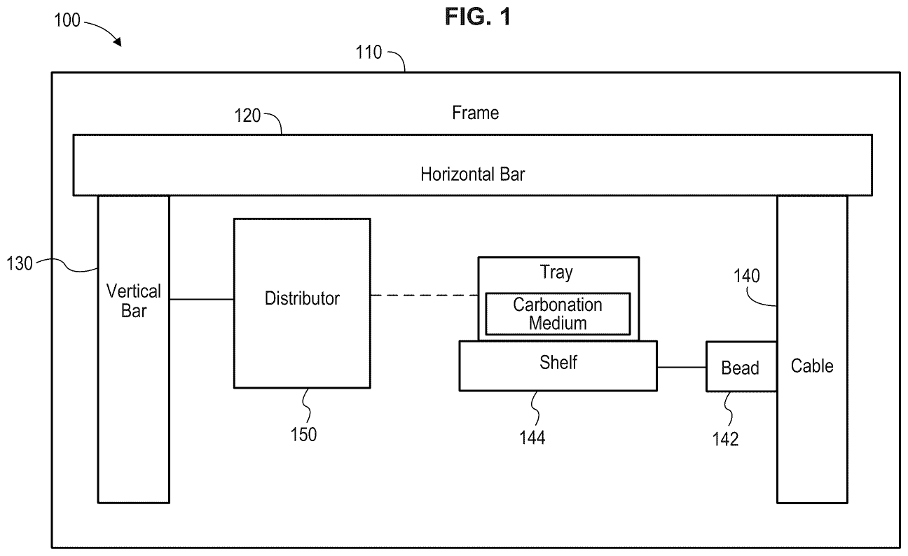

FIG. 1 is a block diagram of a contactor unit 100 for DAC, according to an embodiment. The contactor unit includes a frame 110 having a horizontal bar 120 and a vertical bar 130, a cable 140, and a distributor 150. In some embodiments, the horizontal bar 120 is stacked on top of the vertical bar 130. In some embodiments, the frame 110 can include multiple horizontal bars 120 and/or vertical bars 130. In some embodiments, the frame 110 can include about 1, about 2, about 3, about 4, about 5, about 6, about 7, about 8, about 9, about about 11, about 12, about 13, about 14, about 15, about 16, about 17, about 18, about 19, about 20, about 25, about 30, about 35, about 40, about 45, about 50, about 55, about 60, about about 70, about 75, about 80, about 85, about 90, about 95, or about 100 horizontal bars 120 and/or vertical bars 130, inclusive of all values and ranges therebetween.

In some embodiments, the horizontal bars 120 and/or the vertical bars 130 can include beams. In some embodiments, the horizontal bars 120 and/or the vertical bars 130 can include I-beams (universal beams), hip beams, trussed beams, composite beams, lattice beams, chilled beams, reinforced concrete beams, steel beams, timber beams, curved beams, straight beams, tie beans, cantilever beans, or any other suitable beam type or combinations thereof. In some embodiments, the horizontal bars 120 and/or the vertical bars 130 can be composed of metal, steel, carbon steel, iron, aluminum, stainless steel, laminate wood, timber, or any combination thereof. In some embodiments, multiple horizontal bars 120 can be arranged atop the vertical bars 130 in a geometric pattern (e.g., a square pattern, a rectangular pattern, a curved elliptical pattern, a curved circle pattern, etc.). In some embodiments, the ratio of vertical bars 130 to horizontal bars 120 can be based on the number of supports needed for the distributors 150. In some embodiments, the ratio of horizontal bars to vertical bars can be about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, or about 10:1, inclusive of all values and ranges therebetween.

In some embodiments, the cable 140 is suspended from the horizontal bar 120. The cable 140 can include beads for engagement with a shelf 144 suspended from the horizontal bar 120. The cable 140 can be robust and taut. In some embodiments, the cable 140 can be composed of steel, carbon steel, non-alloy carbon steel, copper, coated wire rope, or any combination thereof. In some embodiments, the cable 140 can have a thickness of at least about 1 mm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 1.5 cm, at least about 2 cm, at least about 2.5 cm, at least about 3 cm, at least about 3.5 cm, at least about 4 cm, or at least about 4.5 cm. In some embodiments, the cable 140 can have a thickness of no more than about 5 cm, no more than about 4.5 cm, no more than about 4 cm, no more than about 3.5 cm, no more than about 3 cm, no more than about 2.5 cm, no more than about 2 cm, no more than about 1.5 cm, no more than about 1 cm, no more than about 9 mm, no more than about 8 mm, no more than about 7 mm, no more than about 6 mm, no more than about 5 mm, no more than about 4 mm, no more than about 3 mm, or no more than about 2 mm. Combinations of the above-referenced thicknesses of the cable 140 are also possible (e.g., at least about 1 mm and no more than about cm or at least about 5 mm and no more than about 1 cm), inclusive of all values and ranges therebetween. In some embodiments, the cable 140 can have a thickness of about 1 mm, about 1 mm, about 2 mm, about 3 mm, about 4 mm, about 5 mm, about 6 mm, about 7 mm, about 8 mm, about 9 mm, about 1 cm, about 1.5 cm, about 2 cm, about 2.5 cm, about 3 cm, about 3.5 cm, about 4 cm, about 4.5 cm, or about 5 cm.

In some embodiments, the beads 142 can be placed along the length of the cable 140 at predetermined spacing intervals. In some embodiments, the beads 142 can be spaced apart at intervals of at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 20 cm, at least about 30 cm, at least about 40 cm, at least about 50 cm, at least about 60 cm, at least about 70 cm, at least about 80 cm, or at least about 90 cm. In some embodiments, the beads 142 can be spaced apart at intervals of no more than about 1 m, no more than about 90 cm, no more than about 80 cm, no more than about 70 cm, no more than about 60 cm, no more than about 50 cm, no more than about 40 cm, no more than about 30 cm, no more than about 20 cm, no more than about 10 cm, no more than about 9 cm, no more than about 8 cm, no more than about 7 cm, no more than about 6 cm, no more than about 5 cm, no more than about 4 cm, no more than about 3 cm, or no more than about 2 cm. Combinations of the above-referenced spacings of the beads 142 are also possible (e.g., at least about 1 cm and no more than about 1 m or at least about 3 cm and no more than about cm), inclusive of all values and ranges therebetween. In some embodiments, the beads 142 can be spaced apart at intervals of about 1 cm, about 2 cm, about 3 cm, about 4 cm, about 5 cm, about 6 cm, about 7 cm, about 8 cm, about 9 cm, about 10 cm, about 20 cm, about 30 cm, about 40 cm, about 50 cm, about 60 cm, about 70 cm, about 80 cm, about 90 cm, or about 1 m.

In some embodiments, the bead 142 supports the shelf 144. In some embodiments, the shelf 144 can snap, bolt, and/or bond to the bead 142. In some embodiments, multiple shelves 144 can be placed on multiple beads 142. In some embodiments, the shelves 144 can have holes with a larger section and a smaller section, such that the beads 142 can be threaded through the larger sections and moved relative to the hole to be under the smaller sections of the holes. This enables the smaller sections of the holes to support the beads 142 such that the shelves 144 can rest on the beads 142. In some embodiments, the beads 142 can have grooves into which holes on the shelves 144 can fit. In some embodiments, the beads 142 can be distinct pieces of material attached to the cable 140 by crimping, welding, brazing, soldering, adhesive, or any other suitable attachment method or combinations thereof. In some embodiments, a casting or coating can be applied around the outside of the beads 142 and the cable 140 to form a permanent assembly or a permanent connection between the beads 142 and the cable 140. In some embodiments, the casting material can be composed of zinc, tin, aluminum, copper, magnesium, tin, iron, low carbon steel, high carbon steel, white cast iron, gray cast iron, ductile cast iron, or any combination thereof. In some embodiments, the shelves 144 can be removably coupled to the cable 140. In other words, the shelves 144 can be replaceable.

The distributor 150 collects a tray with the carbonation medium disposed therein and pulls the tray into the body of the distributor 150. In some embodiments, the distributor 150 can move vertically along the vertical bar 130. In some embodiments, the contactor unit 100 can include multiple distributors 150 disposed therein. In some embodiments, the contactor unit 100 can include about 1, about 2, about 3, about 4, about 5, about 6, about 7, about 8, about 9, about 10, about 11, about 12, about 13, about 14, about 15, about 16, about 17, about 18, about 19, about 20, about 25, about 30, about 35, about 40, about 45, about 50, about 55, about 60, about 65, about 70, about 75, about 80, about 85, about 90, about 95, or about 100 distributors 150, inclusive of all values and ranges therebetween. In some embodiments, the carbonation medium can include a sorbent. In some embodiments, the carbonation medium can include calcium oxide, calcium hydroxide, magnesium oxide, magnesium hydroxide, sodium oxide, sodium hydroxide, or dolomitic lime (calcium-magnesium oxide or hydroxide). In some embodiments, the carbonation medium can be in a powder form. In some embodiments, the carbonation medium can have any of the properties described in the '910 publication or the '336 publication.

In some embodiments, the contactor unit 100 can include an air conveyor (not shown), which forces air through the trays and the shelves 144. The air conveyor can include a fan, a louver, and/or any other similar air movement system. In some embodiments, the air conveyor can be attached to the vertical bar 130. In some embodiments, the air conveyor can be attached to the horizontal bar 120.

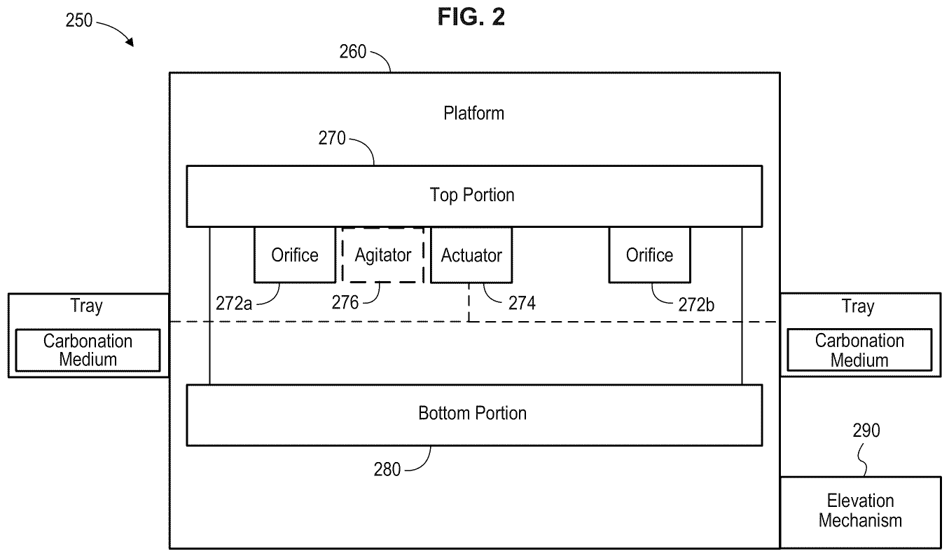

FIG. 2 is a block diagram of a distributor 250, according to an embodiment. In some embodiments, the distributor 250 includes a platform 260 with a top portion 270, a bottom portion 280, and an elevation mechanism 290. The top portion 270 can include orifices 272a, 272b (collectively referred to as orifices 272), and an actuator 274. In some embodiments, the top portion 270 can include an optional agitator 276. In some embodiments, the distributor 250 can be the same or substantially similar to the distributor 150, as described above with reference to FIG. 1. Thus, certain aspects of the distributor 250 are not described in greater detail herein.

In some embodiments, the platform 260 includes the top portion 270 (also referred to as ceiling) as well as the bottom portion 280 (also referred to as floor). In some embodiments, the platform 260 can be hollow, such that it includes a void space between the bottom portion 280 and the top portion 270. In some embodiments, the top portion 270 can include a plurality of bars extending along the top of the platform 260. In some embodiments, the bars can be arranged parallel to each other. In some embodiments, the bars can include hollow conduits for the movement of liquid therethrough. Liquid passes through the top portion 270 and is released from the orifices 272a, 272b in the top portion 270 onto the trays, such that the liquid interacts with the carbonation medium in the trays. The bottom portion 280 supports the trays when they get pulled into the center of the platform 260. In some embodiments, the bottom portion 280 can include a plurality of bars. In some embodiments, the plurality of bars in the bottom portion 280 can be arranged parallel to one another. In some embodiments, a portion of the bars in the bottom portion 280 can be arranged perpendicular to one another.

In some embodiments, two orifices 272 are included in the top portion 270. In some embodiments, the top portion 270 can include at least about 1, at least about 2, at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, or at least about 90 orifices 272. In some embodiments, the top portion 270 can include no more than about 100, no more than about 90, no more than about 80, no more than about 70, no more than about 60, no more than about 50, no more than about 40, no more than about 30, no more than about 20, no more than about 10, no more than about 9, no more than about 8, no more than about 7, no more than about 6, no more than about 5, no more than about 4, no more than about 3, or no more than about 2 orifices 272.

Combinations of the above-referenced numbers of orifices 272 are also possible (e.g., at least about 1 and no more than about 100 or at least about 10 and no more than about 60), inclusive of all values and ranges therebetween. In some embodiments, the top portion 270 can include about 1, about 2, about 3, about 4, about 5, about 6, about 7, about 8, about 9, about about 20, about 30, about 40, about 50, about 60, about 70, about 80, about 90, or about 100 orifices 272. In some embodiments, the orifices 272 can include nozzles. In some embodiments, the nozzles can have variable spray angles. In some embodiments, the nozzles can aim downward and can be adjusted to aim diagonally and/or horizontally. In some embodiments, the orifices 272 can include flat fan nozzles, hollow cone nozzles, full cone nozzles, misting nozzles, solid stream nozzles, air atomizing nozzles, spillback nozzles, eductor nozzles, or any combination thereof.

In some embodiments, when in use, the total flow rate of liquid through the orifices 372 can be at least about 1 mL/min, at least about 2 mL/min, at least about 3 mL/min, at least about 4 mL/min, at least about 5 mL/min, at least about 6 mL/min, at least about 7 mL/min, at least about 8 mL/min, at least about 9 mL/min, at least about 10 mL/min, at least about 20 mL/min, at least about 30 mL/min, at least about 40 mL/min, at least about 50 mL/min, at least about 60 mL/min, at least about 70 mL/min, at least about 80 mL/min, at least about 90 mL/min, at least about 100 mL/min, at least about 150 mL/min, at least about 200 mL/min, at least about 250 mL/min, at least about 300 mL/min, at least about 350 mL/min, at least about 400 mL/min, or at least about 450 mL/min. In some embodiments, when in use, the total flow rate of liquid through the orifices 272 can be no more than about 500 mL/min, no more than about 450 mL/min, no more than about 400 mL/min, no more than about 350 mL/min, no more than about 300 mL/min, no more than about 250 mL/min, no more than about 200 mL/min, no more than about 150 mL/min, no more than about 150 mL/min, no more than about 100 mL/min, no more than about 90 mL/min, no more than about 80 mL/min, no more than about mL/min, no more than about 60 mL/min, no more than about 50 mL/min, no more than about 40 mL/min, no more than about 30 mL/min, no more than about 20 mL/min, no more than about 10 mL/min, no more than about 9 mL/min, no more than about 8 mL/min, no more than about 7 mL/min, no more than about 6 mL/min, no more than about 5 mL/min, no more than about 4 mL/min, no more than about 3 mL/min, or no more than about 2 mL/min.

Combinations of the above-referenced flow rates of the liquid through the orifices 272 are also possible (e.g., at least about 1 mL/min and no more than about 500 mL/min or at least about 10 mL/min and no more than about 150 mL/min), inclusive of all values and ranges therebetween. In some embodiments, when in use, the total flow rate of liquid through the orifices 272 can be about 1 mL/min, about 2 mL/min, about 3 mL/min, about 4 mL/min, about mL/min, about 6 mL/min, about 7 mL/min, about 8 mL/min, about 9 mL/min, about 10 mL/min, about 20 mL/min, about 30 mL/min, about 40 mL/min, about 50 mL/min, about 60 mL/min, about 70 mL/min, about 80 mL/min, about 90 mL/min, about 100 mL/min, about 150 mL/min, about 200 mL/min, about 250 mL/min, about 300 mL/min, about 350 mL/min, about 400 mL/min, about 450 mL/min, or about 500 mL/min.

The actuator 274 engages with trays on either side and transfers the trays into the body of the platform 260. In some embodiments, the actuator 274 can include arms and/or fingers that extend outward to engage with the trays to bring them into the body of the platform 260. In some embodiments, the actuator 274 can be mounted to the top portion 270 of the platform 260. In some embodiments, the actuator 274 engages with trays on two sides. In some embodiments, the actuator 274 can engage with trays on 1 side, 2 sides, 3 sides, 4 sides, or more than 4 sides if the geometric configuration of the distributor 250 and the contactor unit (not shown) allows for such collection. In some embodiments, the platform 260 includes one actuator 274. In some embodiments, the platform 260 can include multiple actuators 274. In some embodiments, the platform 260 can include an actuator for each side of the platform 260. In some embodiments, the platform 260 can include about 1, about 2, about 3, about 4, about about 6, about 7, about 8, about 9, or about 10 actuators 274, inclusive of all values and ranges therebetween.

In some embodiments, the optional agitator 276 can agitate the carbonation medium in the trays to promote interaction between the liquid and the carbonation medium. In some embodiments, the agitator 276 can include a blade, an impeller, a stirring element, an irrigation element, a stir bar, a vibration element, or any other stirring or agitation mechanism, or combinations thereof. In some embodiments, the agitator 276 is suspended from the top portion 270 of the platform 260. In some embodiments, the agitator 276 can be appended to the bottom portion 280 of the platform 260. For example, the agitator 276 can include a vibration element that makes contact with trays and shakes the trays. In some embodiments, the bottom portion 280 can include a load cell or a scale configured to measure a weight of the tray with the carbonation medium therein. In some embodiments, the bottom portion 280 can include a weighing platform.

The elevation mechanism 290 aids in moving the platform 260 vertically. In some embodiments, the elevation mechanism 290 can include an engagement mechanism that engages with a cable (e.g., the cable 140) or multiple cables. In some embodiments, the elevation mechanism 290 can include one or more wheels configured to engage with the cable or multiple cables. In some embodiments, the elevation mechanism 290 can engage with vertical bars (e.g., the vertical bars 130). In some embodiments, the elevation mechanism 290 can include one or more wheels that engage with vertical bars. In some embodiments, the elevation mechanism 290 can include a chain driven by a motor. In some embodiments, the elevation mechanism 290 can include a linear actuator driven by a motor.

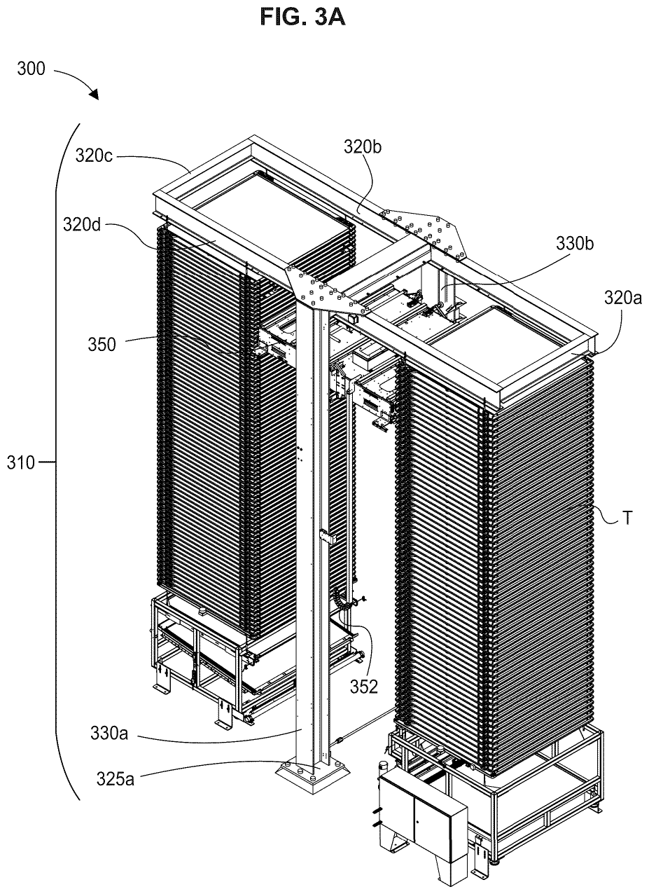

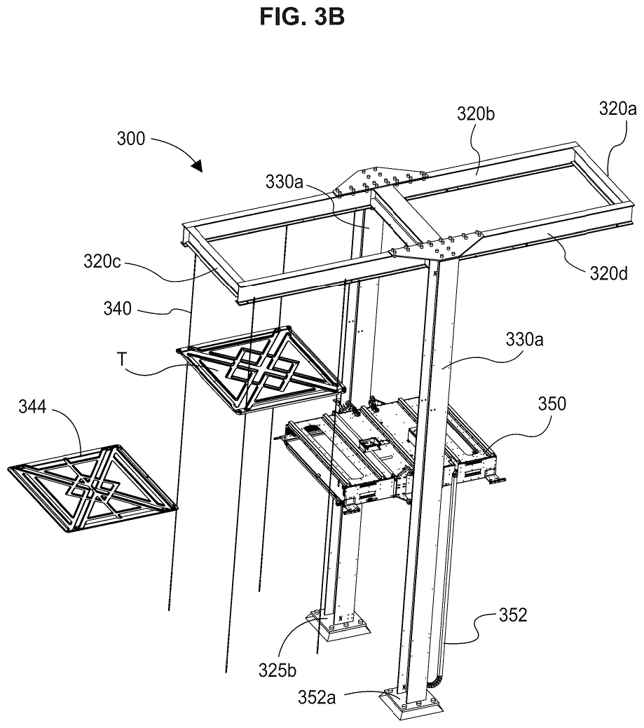

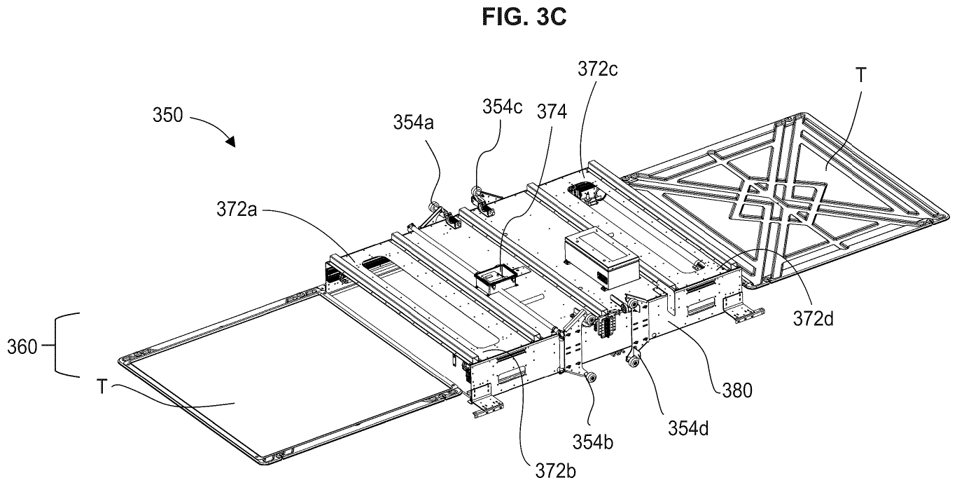

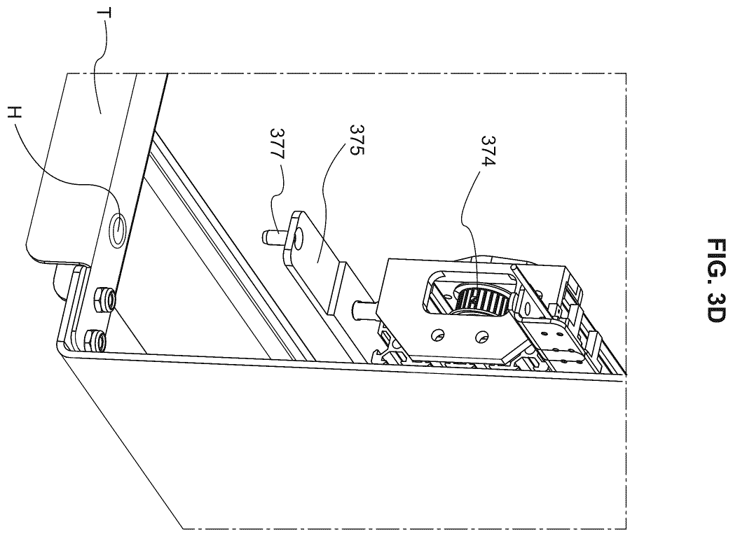

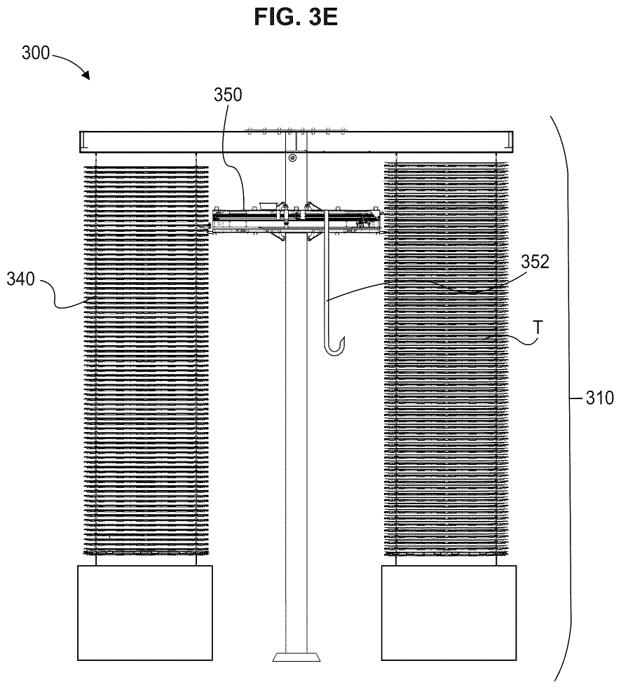

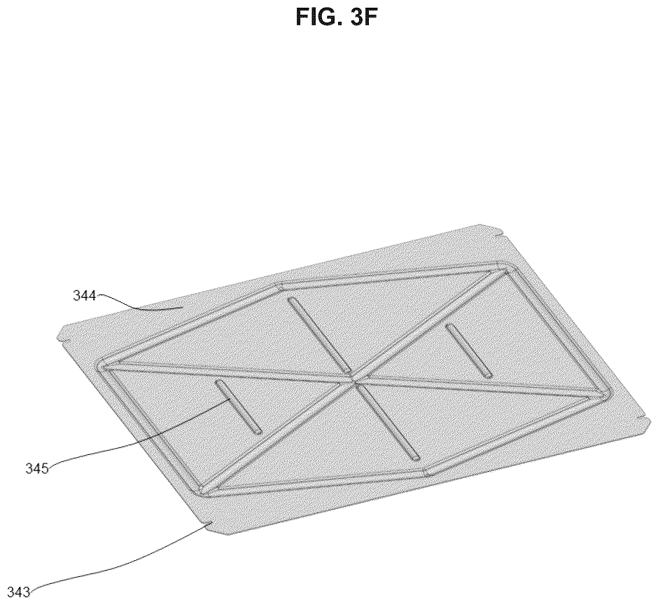

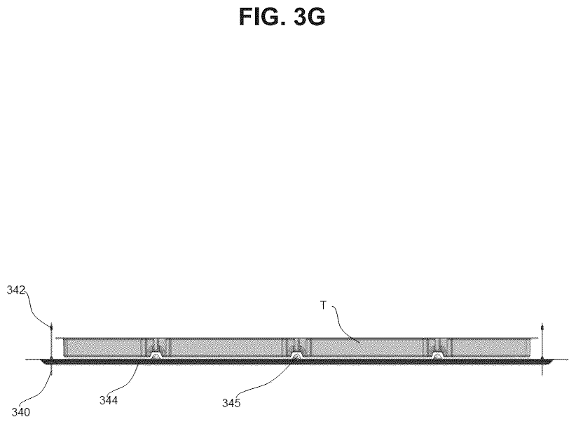

FIGS. 3A-3G are illustrations of a contactor unit 300 and various components thereof, according to an embodiment. As shown, the contactor unit 300 includes a frame 310 with horizontal bars 320a, 320b, 320c, 320d (collectively referred to as horizontal bars 320), a filling station 312, a dumping station 314, support bars 325a, 325b (collectively referred to as support bars 325), vertical bars 330a, 330b (collectively referred to as vertical bars 330), cables 340, shelves 344, and a distributor 350. The distributor 350 includes a cable management mechanism 352, mounting brackets 354a, 354b, 354c, 354d (collectively referred to mounting brackets 354), a platform 360 with a top portion 370 and a bottom portion 380, orifices 372a, 372b, 372c, 372d (collectively referred to as orifices 372), an actuator 374 including an arm 375 and a finger or pin 377. In some embodiments, the frame 310, the horizontal bars 320, the vertical bars 330, and the cables 340 can be the same or substantially similar to the frame 110, the horizontal bars 120, the vertical bars 130, and the cables 140, as described above with reference to FIG. 1. In some embodiments, the distributor 350, the platform 360, the top portion 370, the orifices 372, the actuator 374, and the bottom portion 380 can be the same or substantially similar to the distributor 250, the platform 260, the top portion 270, the orifices 272, the actuator 274, and the bottom portion 280, as described above with reference to FIG. 2. Thus, certain aspects of the frame 310, the horizontal bars 320, the vertical bars 330, the cables 340, the distributor 350, the platform 360, the top portion 370, the orifices 372, the actuator 374, and the bottom portion 380 are not described in greater detail herein. FIG. 3A shows the distributor 350 incorporated into the frame 310 and engaging with trays T. FIG. 3B shows the distributor 350 in the frame 310 and the shelf 344 and tray T in greater detail. FIG. 3C shows the distributor 350 in greater detail. FIG. 3D shows the actuator 374 engaging with a tray T. FIG. 3E shows a cross-sectional view of the distributor 350 interacting with the trays T in the frame 310.

FIG. 3A shows the contactor unit 300 with the distributor 350. The frame 310 includes the base support bars 325 supporting the vertical bars 330 and the horizontal bars 320. The support bars 325 have a breadth significant enough to prevent rocking and loss of balance by the frame 310. In some embodiments, the frame 310 can include the same number of support bars 325 as vertical bars 330. In some embodiments, the frame 310 can include multiple vertical bars 330 attached to each of the support bars 325. As shown, the horizontal bars 320 are oriented in a rectangular pattern. In some embodiments, the horizontal bars 320 can be oriented in a square pattern, a circular pattern, an elliptical pattern, or any other suitable pattern. In some embodiments, the contactor unit 300 can include an intrusion prevention mechanism surrounding the frame 310. In some embodiments, the intrusion prevention mechanism can prevent external influences from contacting the trays T and the distributor(s) 350. In some embodiments, the intrusion prevention mechanism can include a sheet of material that can block wind or rain from intruding or interacting with the carbonation medium in the trays T. In some embodiments, the intrusion prevention mechanism can include a barrier to prevent vandalism. In some embodiments, the intrusion prevention mechanism can include a mesh, a netting, a fence, and/or a chain link fence.

FIG. 3B shows greater detail of the shelf 344. In some embodiments, the frame 310 can include many shelves 344. The shelf 344 provides support for trays T. The vertical arrangement of the shelves 344 allows material to be stacked vertically, minimizing land area requirements. In some embodiments, each set of the vertical bars 330 can include at least about 2, at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, at least about 90, at least about 100, at least about 200, at least about 300, at least about 400, at least about 500, at least about 600, at least about 700, at least about 800, or at least about 900 shelves 344. In some embodiments, each set of the vertical bars 330 can include no more than about 1,000, no more than about 900, no more than about 800, no more than about 700, no more than about 600, no more than about 500, no more than about 400, no more than about 300, no more than about 200, no more than about 100, no more than about 90, no more than about 80, no more than about 70, no more than about 60, no more than about 50, no more than about 40, no more than about 30, no more than about 20, no more than about 10, no more than about 9, no more than about 8, no more than about 7, no more than about 6, no more than about 5, no more than about 4, or no more than about 3 shelves 344. Combinations of the above-referenced numbers of shelves 344 are also possible (e.g., at least about 2 shelves 344 and no more than about 1,000 shelves 344 or at least about 10 shelves 344 and no more than about 100 shelves 344), inclusive of all values and ranges therebetween. In some embodiments, each of the vertical bars 330 can include about 2, about 3, about 4, about 5, about 6, about 7, about 8, about 9, about 10, about 20, about 30, about 40, about 50, about 60, about 70, about 80, about 90, about 100, about 200, about 300, about 400, about 500, about 600, about 700, about 800, about 900, or about 1,000 shelves 344.

In some embodiments, the shelves 344 can be spaced apart by at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 20 cm, at least about 30 cm, at least about 40 cm, at least about 50 cm, at least about 60 cm, at least about 70 cm, at least about 80 cm, or at least about 90 cm. In some embodiments, the shelves 344 can be spaced apart by no more than about 1 m, no more than about 90 cm, no more than about 80 cm, no more than about 70 cm, no more than about 60 cm, no more than about 50 cm, no more than about 40 cm, no more than about 30 cm, no more than about 20 cm, no more than about 10 cm, no more than about 9 cm, no more than about 8 cm, no more than about 7 cm, no more than about 6 cm, no more than about 5 cm, no more than about 4 cm, no more than about 3 cm, or no more than about 2 cm. Combinations of the above-referenced spacings of the shelves 344 are also possible (e.g., at least about 1 cm and no more than about 1 m or at least about 10 cm and no more than about 50 cm), inclusive of all values and ranges therebetween. In some embodiments, the shelves 344 can be spaced apart by about 1 cm, about 2 cm, about 3 cm, about 4 cm, about 5 cm, about 6 cm, about 7 cm, about 8 cm, about 9 cm, about 10 cm, about 20 cm, about 30 cm, about 40 cm, about 50 cm, about 60 cm, about 70 cm, about 80 cm, about 90 cm, or about 1 m. In some embodiments, the shelves can be spaced apart to allow for the trays T to sit on the shelves 344 with an air gap of at least about 1 mm or at least about 2 mm.

In some embodiments, the shelves 344 can each have lengths and/or widths of at least about 10 cm, at least about 20 cm, at least about 30 cm, at least about 40 cm, at least about 50 cm, at least about 60 cm, at least about 70 cm, at least about 80 cm, at least about 90 cm, at least about 1 m, at least about 1.5 m, at least about 2 m, at least about 2.5 m, at least about 3 m, at least about 3.5 m, at least about 4 m, or at least about 4.5 m. In some embodiments, the shelves 344 can each have lengths and/or widths of no more than about 5 m, no more than about 4.5 m, no more than about 4 m, no more than about 3.5 m, no more than about 3 m, no more than about 2.5 m, no more than about 2 m, no more than about 1.5 m, no more than about 1 m, no more than about 90 cm, no more than about 80 cm, no more than about 70 cm, no more than about 60 cm, no more than about 50 cm, no more than about 40 cm, no more than about cm, or no more than about 20 cm. Combinations of the above-referenced dimensions of the shelves 344 are also possible (e.g., at least about 10 cm and no more than about 5 m or at least about 50 cm and no more than about 4 m), inclusive of all values and ranges therebetween. In some embodiments, the shelve 344 can each have lengths and/or widths of about 10 cm, about cm, about 30 cm, about 40 cm, about 50 cm, about 60 cm, about 70 cm, about 80 cm, about cm, about 1 m, about 1.5 m, about 2 m, about 2.5 m, about 3 m, about 3.5 m, about 4 m, about 4.5 m, or about 5 m.

In some embodiments, the shelves 344 can be composed of plastic, metal, aluminum, stainless steel, or any other weather resistant material. In some embodiments, the shelves 344 can include stiffening features of various patterns, such as horizontal ribbing, diagonal X-ribbing, and/or deep draws to provide structural integrity to the shelves 344. In some embodiments, the shelves 344 can include features such as locating walls and detents to capture the tray T at a specific location. The locating walls can include an elevated border on one or more sides of the shelves 344 (i.e., on one side, two sides, three sides, four sides, etc.). This can effectively create a cavity that matches the exterior shape of the tray T in order to locate the tray T in a horizontal aspect. In some embodiments, the detent can include a threshold at a lower height than the elevated border or the locating walls, such that the detent allows the tray T to pass over the detention, but offers resistance to an undesired collision or an unintentional wall.

In some embodiments, the carbonation medium held in the trays T can have a thickness of about 1 mm, about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, or about 20 mm, inclusive of all values and ranges therebetween. In some embodiments, the trays T can include about 1, about 2, about 3, about 4, about 5, about 6, about 7, about 8, about 9, or about 10 layers of carbonation medium, inclusive of all values and ranges therebetween.

In some embodiments, the trays T can each have lengths and/or widths of at least about cm, at least about 20 cm, at least about 30 cm, at least about 40 cm, at least about 50 cm, at least about 60 cm, at least about 70 cm, at least about 80 cm, at least about 90 cm, at least about 1 m, at least about 1.5 m, at least about 2 m, at least about 2.5 m, at least about 3 m, at least about 3.5 m, at least about 4 m, or at least about 4.5 m. In some embodiments, the trays T can each have lengths and/or widths of no more than about 5 m, no more than about 4.5 m, no more than about 4 m, no more than about 3.5 m, no more than about 3 m, no more than about 2.5 m, no more than about 2 m, no more than about 1.5 m, no more than about 1 m, no more than about 90 cm, no more than about 80 cm, no more than about 70 cm, no more than about 60 cm, no more than about 50 cm, no more than about 40 cm, no more than about 30 cm, or no more than about 20 cm. Combinations of the above-referenced dimensions of the trays T are also possible (e.g., at least about 10 cm and no more than about 5 m or at least about 50 cm and no more than about 4 m), inclusive of all values and ranges therebetween. In some embodiments, the trays T can each have lengths and/or widths of about 10 cm, about 20 cm, about 30 cm, about 40 cm, about 50 cm, about 60 cm, about 70 cm, about 80 cm, about 90 cm, about 1 m, about 1.5 m, about 2 m, about 2.5 m, about 3 m, about 3.5 m, about 4 m, about 4.5 m, or about 5 m.

In some embodiments, the trays T can have a lip height of at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 1.5 cm, at least about 2 cm, at least about 2.5 cm, at least about 3 cm, at least about 3.5 cm, at least about 4 cm, or at least about 4.5 cm. In some embodiments, the trays T can have a lip height of no more than about 5 cm, no more than about 4.5 cm, no more than about 4 cm, no more than about 3.5 cm, no more than about 3 cm, no more than about 2.5 cm, no more than about 2 cm, no more than about 1.5 cm, no more than about 1 cm, no more than about 9 mm, no more than about 8 mm, no more than about 7 mm, no more than about 6 mm, no more than about 5 mm, no more than about 4 mm, no more than about 3 mm, or no more than about 2 mm. Combinations of the above-referenced lip heights of the trays T are also possible (e.g., at least about 1 mm and no more than about 5 cm or at least about 4 mm and no more than about 3 cm), inclusive of all values and ranges therebetween. In some embodiments, the trays T can have a lip height of about 1 mm, about 2 mm, about 3 mm, about 4 mm, about 5 mm, about 6 mm, about 7 mm, about 8 mm, about 9 mm, about 1 cm, about 1.5 cm, about 2 cm, about 2.5 cm, about 3 cm, about 3.5 cm, about 4 cm, about 4.5 cm, or about 5 cm. In some embodiments, the trays T can have a pattern that allows them to fit directly onto the shelves 344 and inhibit movement of the trays T once in place.

In some embodiments, the cables 340 can move to elevate and lower the trays T. In some embodiments, the cables 340 can be coupled to an advancement mechanism (not shown) housed in the frame 310 that can advance the cables 340 to elevate and lower the trays T. As shown, the cables 340 include the beads 342 for engagement with the shelves 344. The cables 342 are threaded through holes on the shelves 344 and the shelves 344 rest on top of the beads 342. In some embodiments, the shelves 344 can move vertically to elevate or descend to the same height as the distributor 350. As shown, the cable management mechanism 352 is incorporated into the distributor 350. As shown, the cable management mechanism 352 includes a chain. In some embodiments, the cable management mechanism 352 can include an articulated cable carrier. In some embodiments, the cable management mechanism 352 can include an articulated cable protection device. In some embodiments, the cable management mechanism 352 can include an e-Chain®. The cable management mechanism 352 ensures that the cable 340 is not bent more than its minimal bend radius while the distributor 350 moves vertically. In some embodiments, the minimal bend radius of the cable 340 can be about 1 cm, about 2 cm, about 3 cm, about 4 cm, about 5 cm, about 6 cm, about 7 cm, about 8 cm, about 9 cm, about 10 cm, about 20 cm, about 30 cm, about 40 cm, about 50 cm, about 60 cm, about 70 cm, about 80 cm, about 90 cm, or about 1 m, inclusive of all values and ranges therebetween.

In some embodiments, the cable(s) 340 can be coupled to a horizontal bracing element (not shown) and/or a diagonal bracing element (not shown). The horizontal and/or diagonal bracing elements can minimize horizontal movement of the cable(s) 340 and prevent disturbance to the trays T and the carbonation medium. In some embodiments, the horizontal and/or diagonal bracing elements can include braces or splints. In some embodiments, the horizontal and/or diagonal bracing elements can be planted in the ground near the frame 310 or under the frame 310. As shown, the contactor unit 300 includes four cables 340 per distributor 350. In some embodiments, the contactor unit 300 can include about 1, about 2, about 3, about 4, about 5, about 6, about 7, about 8, about 9, about 10, about 11, about 12, about 13, about 14, about 15, about 16, about 17, about 18, about 19, or about 20 cables 340 per distributor 350, inclusive of all values and ranges therebetween. The cables 340 can be held in tension, minimizing the movement of the cables 340 and the distributor 350. In some embodiments, the cables 340 can include horizontal bracing at bracing intervals. In some embodiments, the bracing intervals can be about 50 cm, about 60 cm, about 70 cm, about 80 cm, about 90 cm, about 1 m, about 1.1 m, about 1.2 m, about 1.3 m, about 1.4 m, or about 1.5 m, inclusive of all values and ranges therebetween. In some embodiments, the cables 340 can include diagonal or X-bracing from the top of the contactor unit 300 to the bottom of the contactor unit 300

In some embodiments, the distributor 350 can include an elevation mechanism (not shown). In some embodiments, the elevation mechanism can include a motor. In some embodiments, the vertical bars 330 can include one or more counterweights disposed therein. The counterweights are masses that work in the opposite direction of force applied by the distributor 350. By incorporating a counterweight into the vertical bars 330, the loading on the motor in the elevation mechanism can be reduced. For example, while the motor works to elevate the distributor 350, the counterweight moves downward through the vertical bar 330 such that the mass force provided by the counterweight opposes the mass force of the distributor 350, which enables the use of a smaller motor in the elevation mechanism since the total loading on the motor is less than it would be without a counterweight. In other words, use of the counterweight decreases the amount of energy needed to move the distributor 350. In some embodiments, the vertical bars 330 can include one or more fiducials configured to fix heights along the vertically oriented bars, at which the distributor 350 or multiple distributors 350 are fixed while loading the trays T into the distributors 350 and unloading the trays T from the distributors 350.

FIG. 3C shows the distributor 350 in greater detail. As shown, the distributor 350 includes the orifices 372. As shown the orifices 372 disperse liquid over the trays T with carbonation medium disposed in the trays T. The mounting brackets 354 keep the distributor level when the distributor 350 moves vertically. As shown, the wheels mounting brackets 354 are facing away from a centerline or a center of gravity of the distributor 350. The mounting brackets 354 contact the trays T on either side of the distributor and the trays T act as a backstop that the wheels of the mounting brackets 354 interact with to maintain balance. In some embodiments, the wheels of the mounting brackets 354 can face inward such that the mounting brackets 354 contact the vertical bars 330. In such a configuration, the vertical bars 330 provide a backstop that the wheels of the mounting brackets 354 interact with to maintain balance.

FIG. 3D shows a detailed interaction between the actuator 374 and a tray T. As shown, the actuator 374 includes the arm 375 and the finger or pin 377 attached to the arm 375. The arm 375 extends outward from the center of the actuator 374 and the finger 377 points downward and is lowered into a hole H in the tray T. In some embodiments, the finger 377 can point upward and the finger 377 can engage with the hole H from below the hole H. As shown, the actuator 374 includes a single finger 377 and the tray T includes a single hole H. In some embodiments, the actuator 374 can include multiple fingers 377 to engage with multiple holes H on the tray T. In some embodiments, the actuator 374 can include about 2, about 3, about 4, about 5, about 6, about 7, about 8, about 9, or about 10 fingers 377, inclusive of all values and ranges therebetween. In some embodiments, the tray can include about 2, about 3, about 4, about 5, about 6, about 7, about 8, about 9, or about 10 holes H, inclusive of all values and ranges therebetween.

After engaging the tray T, the actuator 374 urges the tray T toward the center of the distributor 350, such that the orifices 372 dispose the liquid onto the tray T. In some embodiments, the arm 375 can extend relative to a stationary actuator 374, such that the finger 377 lines up with the hole H to engage the tray T. In some embodiments, the arm 375 can have a fixed length relative to the center of the actuator 374 and the actuator 374 can move relative to the center of the distributor 350 to engage the tray T. As shown, the actuator 374 includes two arms 375 and two fingers 377. In some embodiments, a first finger can be positioned to engage with a tray on a first side of the distributor 350 and a second finger can be positioned opposite the first finger, such that the second pin can engage with a tray on a second side of the distributor 350, the second side opposite the first side. In some embodiments, the distributor 350 can include multiple actuators 374, and each of the actuators 374 can include a single arm 375 and a single finger 377. In some embodiments, the movement of the distributor 350, the orifices 372, and the actuator 374 can be automated and guided by algorithms.

FIG. 3E shows a cross-sectional view of the contactor unit 300 with the filling station 312 and the dumping station 314. In use, the distributor 350 migrates trays T from the filling station 312 to dumping station 314. In some embodiments, the distributor 350 can pull trays from the filling station 312 and push them into the dumping station 314. The filling station 312 and the dumping station 314 are optional features that can aid in efficient movement of the trays T. In some embodiments, the contactor unit 300 can include a caddy dock (not shown). The caddy dock can be integrated into the filling station 312 or in close proximity to the filling station 312. The caddy dock can serve as a location where filled trays T can be deposited or docked onto the contactor 300 before the distributor 350 places the trays T within the contactor unit 300.

In use, a thin layer of carbonation medium is distributed onto each of the trays T in the filling station 312. The distributor 350 transports the tray T from the filling station 312 to a specified location in the contactor unit 300 (e.g., the dumping station 314). In some embodiments, the distributor 350 can move vertically to align the tray T with the desired shelf 344, where the distributor 350 dispenses the tray T onto the shelf 344. In some embodiments, this can be repeated until every shelf 344 has a tray T placed thereon. The distributor 350 then brings trays T into the body of the distributor 350 and processes the trays T (e.g., via addition of water, agitation, and/or other methods) at a frequency that can be dictated by software and a controls algorithm. Processing continues until the carbonation medium reaches a suitable reaction extent. Once the carbonation medium has reacted sufficiently, the distributor 350 can retrieve each tray T individually and move each tray T to the dumping station 314. In the dumping station 314, carbonation medium is removed from each tray T. Each tray T is then sent back to the filling station 312. The collected carbonation medium can then be sent to carbonation plot (e.g., the carbonation plots described in the '336 publication) for carbon capture of ambient air.

In some embodiments, the filling station 312 can include a feeding mechanism to dispose carbonation medium into the trays T. In some embodiments, the filling station 312 can include a vibrating pan feeder, a rotary doser, and/or linearly translating rolling shafts. In some embodiments, the contactor unit 300 can include equipment to collect material from the trays T. This can include one or more rotating arms to rotate the trays T between about 0 degrees and about 180 degrees, agitators to agitate the carbonation medium in the trays T, and/or a vacuum to vacuum the carbonation medium off of the trays T.

In some embodiments, the filling station 312 and/or the dumping station 314 can be positioned outside of the contactor unit 300. In some embodiments, the filling station 312 and/or the dumping station 314 can be placed on a moving platform (e.g., an automated guided vehicle) and service multiple contractor units. In such a setup, the distributor 350 can place a tray T in a moving module to fill the tray T with carbonation medium or dump carbonation medium from the tray T, and then the tray T would be placed back into the contactor unit 310. Alternatively, two moving modules (e.g., one filling module and one dumping module) can approach the contractor unit 310, and the distributor 350 can load a full tray T into the dumping module and a full tray from the filling module can move into the distributor 350.

The design of the contactor unit 300 allows the carbonation medium to contact ambient air, maximizing the exposed surface area of carbonation medium and limiting land usage. The shelf-and-tray configuration of the contactor unit 300 can be absent of forced airflow, rather allowing the carbonation medium to take up CO₂ using natural convection across earth's surface (i.e., wind). Additionally, the contactor unit 300 enables processing of carbonation medium periodically, in an automated manner, to maintain elevated CO₂ capture (i.e., accelerated carbonation rates). The contactor unit 300 also enables automated filling of carbonation medium into the trays T and automated collection of the carbonation medium from the trays. This enables bulk material movement through the contactor unit 300 rather than individual trays T.

In some embodiments, the contactor unit 300 can include one or more sensors (not shown). In some embodiments, the sensors can be internal and/or external to the frame 310. In some embodiments, the sensor(s) can be mounted to the frame 310, shelves 344, trays T, vertical bars 330, horizontal bars 320, and/or the distributor 350. In some embodiments, the sensor(s) can include a load cell, a temperature sensor, an air velocity sensor, a humidity sensor, a precipitation sensor, and/or a solar irradiance sensor.

FIG. 3F shows a detailed view of the shelf 344. As shown, the shelf 344 includes tray alignment features 345 and cable mounting features 343. The tray alignment features 345 allow for secure placement of a tray onto the shelf 344. The tray alignment features 345 can include ridges that fit into grooves on the bottom of a tray. The cable mounting features 343 secure onto the beads 342 of the cables 340. In some embodiments, the cable mounting features 343 can include snap-in features, such that the shelf 344 can snap into the cables 340.

In some embodiments, the mass of the trays T can be measured on the contactor unit 300 (e.g., while the trays T are suspended from the cables 340 and placed on the shelf 344). For example, a sensor can be placed on the horizontal bars 320, the vertical bars 330, and/or the cables 340 to measure deformation and corresponding weight. In some embodiments, a load cell can be integrated into the distributor 350 to measure the mass of the trays T. In some embodiments, a load cell can be placed on top of a caddy dock. In some embodiments, the load cell can be co-located with a tray T on the shelf 344. In some embodiments, the mass of the trays T can be measured external to the contactor unit 300.

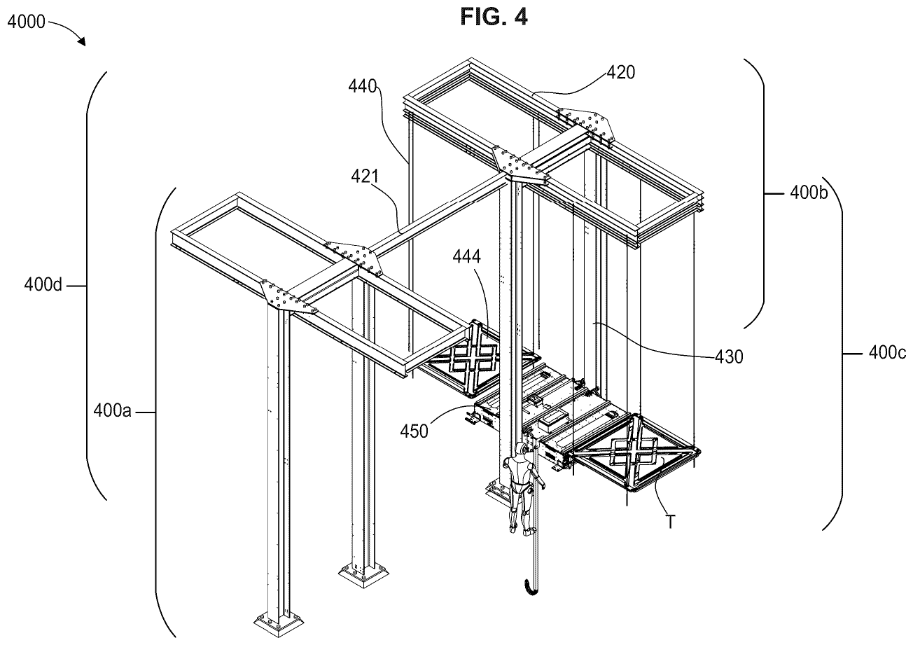

FIG. 4 shows a network 4000 of contactor units 400a, 400b, 400c, 400d (collectively referred to as contactor units 400), according to an embodiment. As shown, the contactor units 400 include horizontal bars 420, crossbars 421, vertical bars 430, cables 440, shelves 444, and a distributor 450. In some embodiments, the horizontal bars 420, the vertical bars 430, the cables 440, the shelves 444, and the distributor 450 can be the same or substantially similar to the horizontal bars 320, the vertical bars 330, the cables 340, the shelves 344, and the distributor 350, as described above with reference to FIGS. 3A-3E. Thus, certain aspects of the horizontal bars 420, the vertical bars 430, the cables 440, the shelves 444, and the distributor 450 are not described in greater detail herein.

The crossbars connect the contactor units 400 to one another. A person in shown in FIG. 4 for scale. As shown, the contactor units 400 have a height of about 10 m. In some embodiments, the contactor units 400 can have a height of at least about 1 m, at least about 2 m, at least about 3 m, at least about 4 m, at least about 5 m, at least about 6 m, at least about 7 m, at least about 8 m, at least about 9 m, at least about 10 m, at least about 20 m, at least about m, at least about 40 m, at least about 50 m, at least about 60 m, at least about 70 m, at least about 80 m, or at least about 90 m. In some embodiments, the contactor units 400 can have a height of no more than about 100 m, no more than about 90 m, no more than about 80 m, no more than about 70 m, no more than about 60 m, no more than about 50 m, no more than about m, no more than about 30 m, no more than about 20 m, no more than about 10 m, no more than about 9 m, no more than about 8 m, no more than about 7 m, no more than about 6 m, no more than about 5 m, no more than about 4 m, no more than about 3 m, or no more than about 2 m. Combinations of the above-referenced heights of the contactor units 400 are also possible (e.g., at least about 1 m and no more than about 100 m or at least about 5 m and no more than about 50 m), inclusive of all values and ranges therebetween. In some embodiments, the about 1 m, about 2 m, about 3 m, about 4 m, about 5 m, about 6 m, about 7 m, about 8 m, about 9 m, about 10 m, about 20 m, about 30 m, about 40 m, about 50 m, about 60 m, about 70 m, about m, about 90 m, or about 100 m. At greater heights, the contactor units 400 can include tension bracing to support the frame material of the contactor units 400. In some embodiments, the contactor units 400 can rely on one another for structural support.

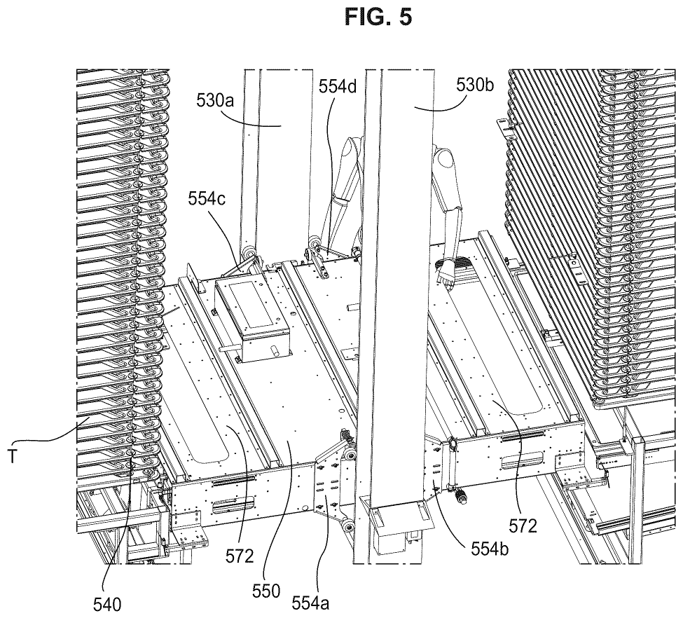

FIG. 5 shows a distributor 550 interacting with vertical bars 530a, 530b (collectively referred to as vertical bars 530) and trays T suspended from cables 540, according to an embodiment. As shown, the distributor 550 includes mounting brackets 554a, 554b, 554c, 554d (collectively referred to as mounting brackets 554), and orifices 572. In some embodiments, the vertical bars 530, the cables 540, the distributor 550, the mounting brackets 554, and the orifices 572 can be the same or substantially similar to the vertical bars 330, the cables 340, the distributor 350, the mounting brackets 354, and the orifices 372, as described above with reference to FIGS. 3A-3E. Thus, certain aspects of the vertical bars 530, the cables 540, the distributor 550, the mounting brackets 554, and the orifices 572 are not described in greater detail herein.

As shown, the mounting brackets contact the vertical bars 530. The distributor 550 moves vertically up and down the vertical bars 530, and the wheels on the mounting brackets 554 contact the vertical bars 530 to maintain balance in the distributor 550. As shown, the mounting brackets 554 are in a fixed position relative to the distributor 550. As shown, the wheels of the mounting brackets 554 face toward the center of the distributor 550. As shown, the distributor 550 includes 4 mounting brackets 554. In some embodiments, the distributor 550 can include about 1, about 2, about 3, about 4, about 5, about 6, about 7, about 8, about 9, about 10, about 11, about 12, about 13, about 14, about 15, about 16, about 17, about 18, about 19, or about 20 mounting brackets 554, inclusive of all values and ranges therebetween.

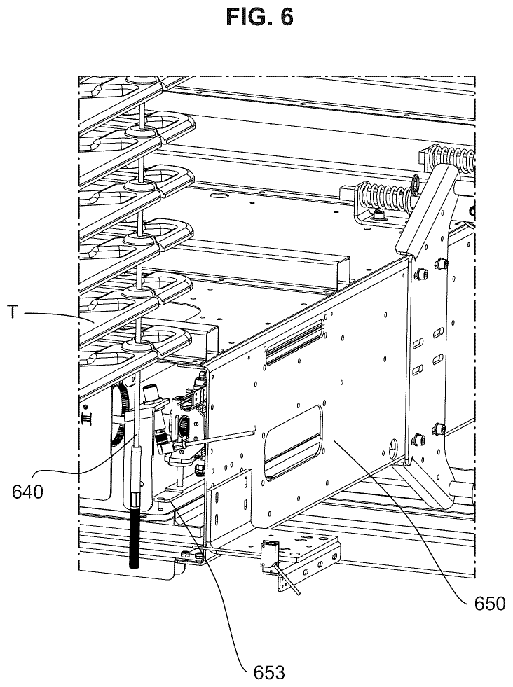

FIG. 6 shows a distributor 650, according to an embodiment. As shown, the distributor engages with a cable 640 that supports trays T. In some embodiments, the distributor 650 and the cable 640 can be the same or substantially similar to the distributor 350 and the cable 340, as described above with reference to FIGS. 3A-3E. Thus, certain aspects of the distributor 650 and the cable 640 are not described in greater detail herein. As shown, the distributor 650 includes a position actuator 653. The position actuator 653 defines a position of a shelf (not shown) with respect to the distributor 650 in a horizontal aspect. In some embodiments, the distributor 650 can remain in a fixed position and urge a shelf to move via a dedicated actuator to achieve a desired shelf position. In other words, the position actuator 653 can detect if the distributor is a desired distance from the trays T, such that an actuator (not shown) can reach out and engage with the trays T. In some embodiments, the horizontal position of the distributor 650 can be adjusted if the position actuator 653 detects that the distributor 650 is not in a desired position relative to the trays T. In some embodiments, the position actuator 653 can include a rotary electric motor driving a linear actuation mechanism, including a belt, chain, linkage, leadscrew, ballscrew, and/or any other suitable components. In some embodiments, the position actuator 653 can include a linear electric motor. In some embodiments, the position actuator 653 can include a linear pneumatic cylinder. In some embodiments, a second position actuator (not shown) can facilitate horizontal movement of the distributor 650 to move the distributor 650 to a desired horizontal position.

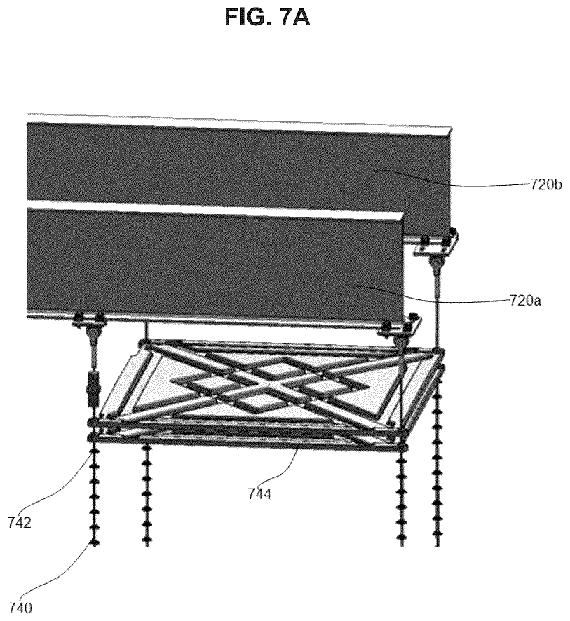

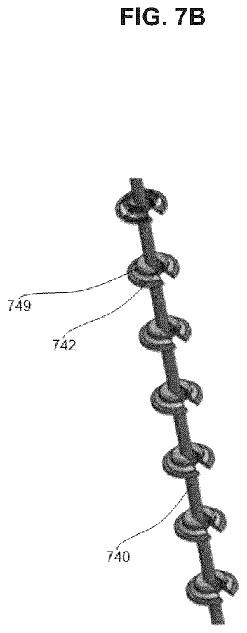

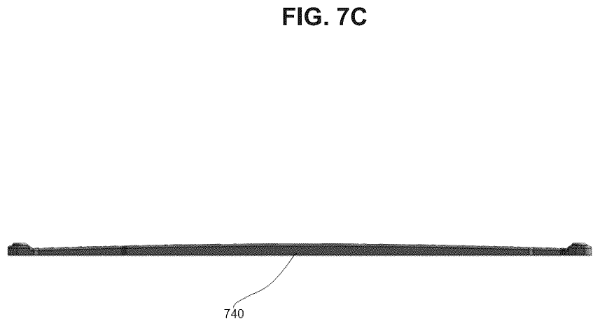

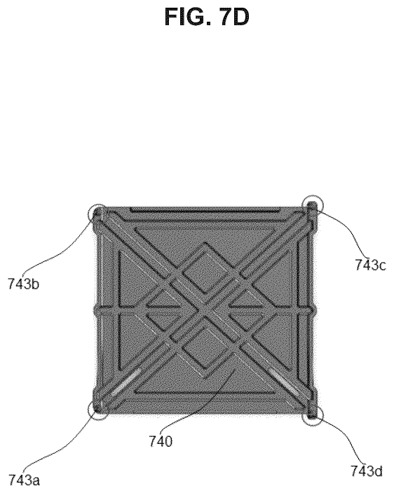

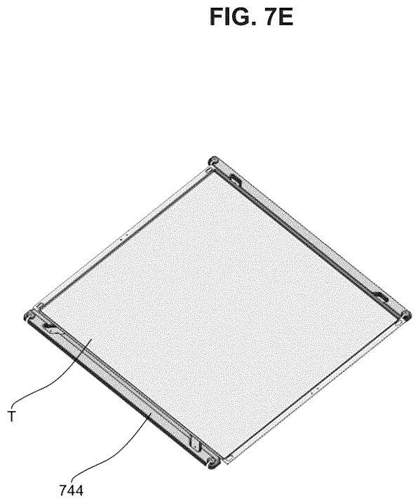

FIGS. 7A-7E are illustrations of a shelf 744 and its interactions with cables 740, according to an embodiment. As shown, the cables 740 are suspended from horizontal bars 720a, 720b (collectively referred to as horizontal bars 720). Beads 742 are attached to the cables 740 and provide supports for the shelf 744. The shelf 744 includes cable mounting features 743a, 743b, 743c, 743d (collectively referred to as cable mounting features 743). In some embodiments, the horizontal bars 720, the cables 740, the beads 742, the cable mounting features 743, and the shelf 744 can be the same or substantially similar to the horizontal bars 320, the cables 340, the beads 342, the cable mounting features 343, and the shelf 344, as described above with reference to FIGS. 3A-3G. Thus, certain aspects of the horizontal bars 720, the cables 740, the beads 742, the cable mounting features 743, and the shelf 744 are not described in greater detail herein.

FIG. 7A shows the interaction between the shelf 744 and the cables 740. As shown, the shelf 744 is suspended from the cables 740 via placement on the beads 742. As shown, four cables 740 are hung from the horizontal bars 720 (with two cables 740 hanging from each of the horizontal bars 720). In some embodiments, the shelf 744 can be supported by about 1, about 2, about 3, about 4, about 5, about 6, about 7, about 8, about 9, or about 10 cables 740. As shown, the beads 742 are swaged onto the cables 740 at a specific pitch.

FIG. 7B shows a detailed view of the cable 740. As shown, the beads 742 are swaged onto the cable 740 while cable pucks 749 are positioned over the beads 742 to increase the surface area that the shelf 744 rests upon. In some embodiments, the cable pucks 749 can be snapped into place over the beads 742. As shown, the cable pucks 749 have a round shape with a groove for placement onto the beads 742. In some embodiments, the cable pucks 749 can have a rectangular or square shape. In some embodiments, the cable pucks 749 can have an elliptical shape.

FIG. 7C shows a profile view of the shelf 744. The design of the shelf 744 can be tailored to optimize for weight, stiffness, durability, and cost. As shown, the horizontal center of the shelf 744 is thicker than the horizontal edges of the shelf 744. This can minimize deflection in the shelf 744 and alleviate concerns associated with pickup of bent trays without requiring significant reinforcing materials.

In some embodiments, the ratio of the thickness of the shelf 744 at its horizontal center to the thickness of the shelf 744 at its horizontal edges can be at least about 1, at least about 1.1, at least about 1.2, at least about 1.3, at least about 1.4, at least about 1.5, at least about 1.6, at least about 1.7, at least about 1.8, at least about 1.9, at least about 2, at least about 2.5, at least about 3, at least about 3.5, at least about 4, at least about 4.5, at least about 5, at least about at least about 6, at least about 6.5, at least about 7, at least about 7.5, at least about 8, at least about 8.5, at least about 9, or at least about 9.5. In some embodiments, the ratio of the thickness of the shelf 744 at its horizontal center to the thickness of the shelf 744 at its horizontal edges can be no more than about 10, no more than about 9.5, no more than about 9, no more than about 8.5, no more than about 8, no more than about 7.5, no more than about 7, no more than about 6.5, no more than about 6, no more than about 5.5, no more than about 5, no more than about 4.5, no more than about 4, no more than about 3.5, no more than about 3, no more than about 2.5, no more than about 2, no more than about 1.9, no more than about 1.8, no more than about 1.7, no more than about 1.6, no more than about 1.5, no more than about 1.4, no more than about 1.3, no more than about 1.2, or no more than about 1.1. Combinations of the above-referenced ratios are also possible (e.g., at least about 1 and no more than about or at least about 1.5 and no more than about 5), inclusive of all values and ranges therebetween. In some embodiments, the ratio of the thickness of the shelf 744 at its horizontal center to the thickness of the shelf 744 at its horizontal edges can be about 1, about 1.1, about 1.2, about 1.3, about 1.4, about 1.5, about 1.6, about 1.7, about 1.8, about 1.9, about 2, about 2.5, about 3, about 3.5, about 4, about 4.5, about 5, about 5.5, about 6, about 6.5, about 7, about 7.5, about 8, about 8.5, about 9, about 9.5, or about 10.

FIG. 7D shows a top view of the shelf 744 and the cable mounting features 743. The cable mounting features 743 are designed to simplify installation and removal of the shelf 744 from the stack of shelves. As shown, the cable mounting features 743c, 743d are positioned further from the horizontal center of the shelf 744 than the cable mounting features 743a, 743b. This allows the shelf 744 to be slid into and out of the stack of shelves without releasing tension from the cables 740 or removing any other part of the contactor.

FIG. 7E shows a tray T positioned on the shelf 744. In some embodiments, the shelf 744 can be composed of acrylonitrile butadiene styrene (ABS) or any other suitable material. In some embodiments, the shelf 744 can be thermoformed. The shelf 744 can have ribs shaped and optimized for ease of manufacturing and reduction of material weight and cost. The trays can be designed to have minimal stiffness while maximizing surface area. In some embodiments, the trays can be designed to maintain uniformity of powder thickness in the tray. In some embodiments, the tray T can rest on the shelf 744 without any interlocking features between the shelf 744 and the tray. Interlocking features can potentially constrain the tray handoff between the distributor and the shelf 744. In some embodiments, the tray T can include radio frequency identification (RFID) stickers that can identify each tray. The trays can accordingly be tracked through software, and the software can store metadata about the trays. In some embodiments, the tray T can include slots machined on its lip that enable pickup and placement between the distributor and the shelf 744 for all tolerance stack-up cases.

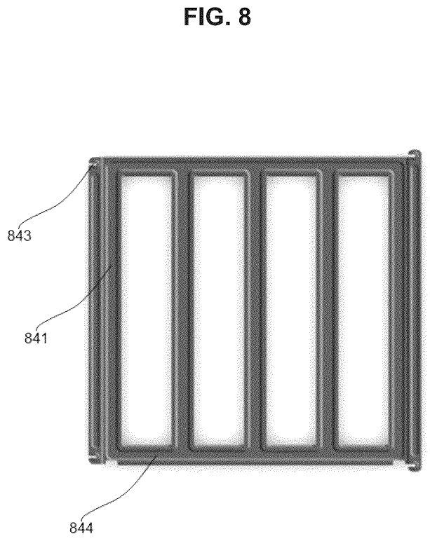

FIG. 8 shows a design of a shelf 844, according to an embodiment. As shown, the tray 844 includes horizontal ribs 841 and cable mounting features 843. In some embodiments, the cable mounting features 843 can be the same or substantially similar to the cable mounting features 743, as described above with reference to FIG. 7A-7E. Thus, certain aspects of the cable mounting features 843 are not described in greater detail herein. As shown, the horizontal ribs 841 enable support of trays placed on the shelf 844 without a large amount of material. The void space of the shelf 844 aids in minimizing the amount of material used to produce the shelf 844. In some embodiments, the tray 844 can be composed of a composite plastic. In some embodiments, the tray 844 can be composed of glass-filled polypropylene.

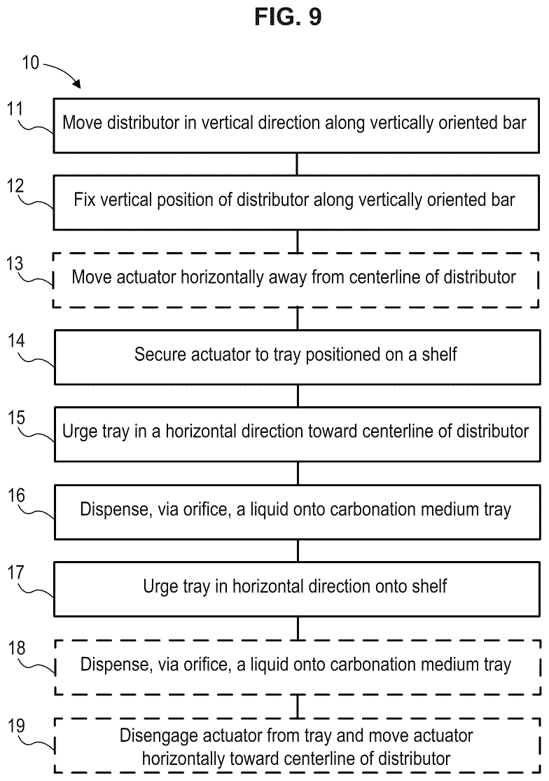

FIG. 9 is a block diagram of a method 10 of operating a distributor, according to an embodiment. As shown, the method 10 includes moving the distributor in a vertical direction along a vertically oriented bar at step 11 and fixing a vertical position of the distributor along the vertically oriented bar at step 12. The method 10 optionally includes moving the actuator horizontally away from a centerline of the distributor at step 13. The method 10 further includes securing the actuator to a tray positioned on a shelf at step 14, urging the tray in a horizontal direction toward the centerline of the distributor at step 15, dispensing, via the orifice, a liquid onto the carbonation medium tray at step 16, and urging the tray in a horizontal direction onto the shelf at step 17. The method 10 optionally includes again dispensing the liquid onto the carbonation medium tray at step 18 and disengaging the actuator from the tray and moving the actuator horizontally toward the centerline of the distributor at step 19.

Step 11 includes moving the distributor in a vertical direction along the vertically oriented bar. In some embodiments, the movement of the distributor can be upward movement. In some embodiments, the movement of the distributor can be downward movement. In some embodiments, the movement of the distributor can be guided by cables attached to the distributor that move the distributor upward and downward. In some embodiments, vertical movement of the distributor can include balancing the distributor via one or more guide wheels. In some embodiments, the distributor can include one or more mounting brackets to orient the guide wheel(s) in a working position.

Step 12 includes fixing the vertical position of the distributor along the vertically oriented bar. In some embodiments, the fixed vertical position can be such that the distributor is aligned vertically with a shelf in the contactor. In some embodiments, the vertical position of the distributor can be detected by a position encoder. In some embodiments, the position actuator can reach outward from the distributor and the vertical position of the distributor relative to a shelf and/or a tray can be detected via the position actuator. In some embodiments, the vertical position of the distributor can be detected via a global positioning system (GPS) device. In some embodiments, the vertical position of the distributor can be detected via one or more fiducials. In some embodiments, the vertical position of the distributor can be detected via a pressure sensor. In some embodiments, the vertical position of the distributor can be detected via a camera or an optical sensor. In some embodiments, fixing the vertical position of the distributor can be done via a locking or a latching mechanism.

Step 13 is optional and includes moving the actuator horizontally away from the centerline of the distributor. In some embodiments, the actuator can remain in contact with a top portion of the distributor as it moves away from the centerline of this distributor. Moving the actuator horizontally away from the centerline of the distributor can aid in capturing a tray. The tray can have carbonation medium disposed therein. In some embodiments, the horizontal movement of the actuator can be in a direction toward the tray to capture the tray. In some embodiments, the movement of the actuator can be toward an outer edge of the distributor. In some embodiments, the movement of the actuator can be beyond the outer edge of the distributor. In some embodiments, step 13 can include moving a first actuator or a first portion of the actuator in a first horizontal direction away from the centerline of the distributor and moving a second actuator or a second portion of the actuator in a second direction away from the centerline of the distributor. In some embodiments, the second horizontal direction can form an angle of about 180 degrees with the first horizontal direction.

Step 14 includes securing the actuator to a tray positioned on a shelf. In some embodiments, the shelf can be suspended from a cable. In some embodiments, the actuator can engage with the tray via an arm and finger mechanism included in the actuator. In some embodiments, the finger of the actuator can engage with a hole in the tray and adjoin the actuator with the tray. In some embodiments, the finger can point downward and the finger can engage with the hole in the tray by first moving horizontally until the finger is positioned over the hole of the tray, and the finger can then be inserted into the hole by lowering the finger into the hole. In some embodiments, step 14 can include securing a first actuator or a first portion of the actuator to a first tray and securing a second actuator or a second portion of the actuator to a second tray. In some embodiments, the second tray can be positioned on an opposite side of the centerline from the first tray.

Step 15 includes urging the tray in a horizontal direction toward the centerline of the distributor. In other words, the tray is pushed and/or pulled into the body of the distributor. In some embodiments, the tray can slide along the bottom portion of the distributor toward the centerline of the distributor. In some embodiments, the movement of the tray in the horizontal direction can be perpetuated by horizontal movement of the finger relative to the centerline of the distributor. In some embodiments, the movement of the tray in the horizontal direction can be perpetuated by horizontal movement of the actuator relative to the centerline of the distributor. In some embodiments, step 15 can include urging the first tray in a first horizontal direction toward the centerline of the distributor and urging the second tray in a second horizontal direction toward the centerline of the distributor. In some embodiments, the second horizontal direction can form an angle of about 180 degrees with the first horizontal direction.

Step 16 includes dispensing via one or more orifices, a liquid onto the carbonation medium tray. Upon dispensation, the liquid interacts with carbonation medium in the tray. In some embodiments, the liquid can include water. In some embodiments, the dispensation of the liquid can be via spraying, misting, dripping, pouring, and/or any other suitable means of conveyance of the liquid. In some embodiments, the liquid can be pressurized upon being released from the orifice(s). In some embodiments, the liquid can be at atmospheric pressure upon being released from the orifice(s). In some embodiments, the liquid can be dispensed at an angle of about 5 degrees, about 10 degrees, about 15 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, about 90 degrees relative to a downward vertical direction, inclusive of all values and ranges therebetween. In some embodiments, the liquid can be dispensed at controlled intervals.

In some embodiments, urging the tray in the horizontal direction toward the centerline of the distributor can occur at least partially concurrent with dispensing the liquid onto the carbonation medium tray. In other words, step 16 can be at least partially concurrent with step 15. In some embodiments, step 16 can be fully concurrent with step 15.

Step 17 includes urging the tray in a horizontal direction back onto the shelf. After the liquid delivery is completed, they tray is placed back onto a shelf. In some embodiments, the tray can be placed back onto the same shelf it was retrieved from at steps 14-15. In some embodiments, the tray can be placed back onto a different shelf from the shelf it was retrieved from at steps 14-15.

Step 18 is optional and includes dispensing via the orifice, the liquid onto the carbonation medium tray. The liquid can be dispensed onto the carbonation medium after the tray is back into its original position on the shelf. In some embodiments, the dispensing can be in a horizontal or diagonal direction away from the centerline of the distributor, such that the liquid can fall into the trays and interact with the carbonation medium.

Step 19 is optional and includes disengaging the actuator from the tray and moving the actuator horizontally toward the centerline of the distributor. In some embodiments, step 19 can include placing the actuator back in its original position. In some embodiments, the actuator can remain in its original position throughout the method 10 and the arm and finger of the actuator can be retracted back toward the centerline of the distributor.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of” “only one of” or “exactly one of” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A device, comprising:
a platform including a top portion and a bottom portion;
an elevation mechanism configured to move the platform vertically;
a plurality of orifices defined by the top portion of the platform, the plurality of orifices configured to dispense liquid toward a tray; and
an actuator configured to move laterally along a bottom side of the top portion of the platform, the actuator configured to urge the tray to move laterally,
wherein the bottom portion is configured to support the tray as the tray moves laterally.

2. The device of claim 1, wherein the elevation mechanism includes at least one of a chain or a linear actuator driven by a motor.

3. The device of claim 1, wherein the tray includes a carbonation medium disposed therein.

4. The device of claim 3, wherein the carbonation medium includes at least one of calcium oxide, calcium hydroxide, magnesium oxide, magnesium hydroxide, sodium oxide, sodium hydroxide, or dolomitic lime (calcium-magnesium oxide or hydroxide).

5. The device of claim 1, wherein the plurality of orifices include spray nozzles configured to spray the liquid onto the tray.

6. The device of claim 5, wherein the spray nozzles have variable spray angles.

7. The device of claim 1, wherein the actuator includes a pin, the pin configured to secure into a hole on the tray to engage the actuator with the tray.

8. The device of claim 7, wherein the pin is a first pin and the tray is a first tray, the actuator further including a second pin, the second pin configured to secure into a hole on a second tray to engage the actuator with the second tray and urge the second tray to move in a direction parallel to the movement of the first tray, the second tray located opposite the first tray relative to the actuator.

9. The device of claim 2, further comprising:
a counterweight configured to minimize loading requirements on the motor.

10. The device of claim 1, wherein the bottom portion of the platform includes a load cell configured to measure a weight of the tray.

11. The device of claim 1, wherein the platform includes a mechanical agitator configured to agitate contents of the tray.

12. The device of claim 11, wherein the mechanical agitator includes at least one of an irrigation implement, a stirring element, and/or a vibration element.

13. An apparatus, comprising:
a frame including a plurality of vertically oriented bars and a plurality of horizontally oriented bars;
a plurality of cables including beads, the plurality of cables coupled to and suspended from the horizontally oriented bars in tension;
a plurality of shelves coupled to the cables and supported by the beads, the plurality of shelves configured to support a plurality of trays; and
a plurality of distributors, each distributor of the plurality of distributors configured to move vertically, each distributor of the plurality of distributors configured to contact a tray from the plurality of trays and urge the tray to move horizontally into and out of the distributor.

14. The apparatus of claim 13, wherein each of the plurality of shelves includes a cable mounting feature configured to couple to the beads.

15. The apparatus of claim 13, further comprising:
a plurality of cable pucks placed upon the beads and configured to increase the surface area upon which each of the plurality of shelves rest.

16. The apparatus of claim 13, wherein each of the plurality of shelves includes an alignment feature configured to engage a tray from the plurality of trays and prevent horizontal sliding of the tray.

17. The apparatus of claim 13, further comprising:
an air conveyor configured to force air through the plurality of shelves and the plurality of trays.

18. The apparatus of claim 13, wherein each of the plurality of vertically oriented bars includes a series of fiducials configured to fix heights along the vertically oriented bars, at which the plurality of distributors are fixed while loading and unloading.

19. The apparatus of claim 13, further comprising:
at least one of a horizontal bracing element or a diagonal bracing element configured to contact at least a portion of the plurality of cables to minimize horizontal movement of the plurality of cables and the plurality of shelves.

20. A method, comprising:
moving a distributor in a vertical direction, the distributor including an actuator and an orifice;
fixing a vertical position of the distributor;
securing the actuator to a tray positioned on a shelf, the tray including a carbonation medium;
urging, via the actuator, the tray in a horizontal direction toward a centerline of the distributor; and
dispensing, via the orifice, a liquid onto the carbonation medium in the tray;

21. The method of claim 20, further comprising: urging, via the actuator, the tray in a horizontal direction onto the shelf.

22. The method of claim 20, further comprising:
disengaging the actuator from the tray and moving the actuator horizontally toward the centerline of the distributor.

23. The method of claim 20, further comprising:
before securing the actuator to the tray, moving the actuator horizontally away from the centerline of the distributor.

24. The method of claim 20, wherein urging the tray in the horizontal direction toward the centerline of the distributor occurs at least partially concurrent with the dispensing.

25. The method of claim 20, wherein the tray is a first tray, the shelf is a first shelf, and the horizontal direction is a first horizontal direction, the method further comprising:
urging, via the actuator, a second tray in a second horizontal direction toward the centerline of the distributor.

26. The method of claim 25, wherein urging the first tray and urging the second tray are at least partially concurrent.

27. The method of claim 25, wherein the second horizontal direction forms an angle of about 180 degrees with the first horizontal direction.
